(19) United States
(12) Patent Application Publication
(10) Pub. No.: US 2009/0036000 A1
(43) Pub. Date: Feb. 5, 2009

(54) Micro USB connector

(76) Inventors: Ning-Lang Cheng, Tu-Cheng City (TW); Yu-Hung Su, Tu-Cheng City (TW); Sheng-Tsung Yuan, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/882,632

(22) Filed: Aug. 3, 2007

(51) Int. Cl. H01R 13/40

(52) U.S. Cl. 439/752.5

(57) ABSTRACT

A micro USB connector includes a housing, contacts received in the housing and a metal shell shielding the housing. The housing has a body, the body has a front wall, the middle of the front wall extends forward to form a mating portion. The metal shell has a top plate, a bottom plate and two side plates, a receiving space is formed among the top plate, the bottom plate and the two side plates. The metal shell extends towards the receiving space to form at least one blocking portion. The body is received in the rear of the receiving space, the mating portion is received in the front of the receiving space, a front end of the blocking portion is at the front of the front wall of the body. Therefore, the electrical connection between the micro USB connector and the plug is reliable.

### BACKGROUND OF THE INVENTION

1. Field of the Invention

The present invention relates to a micro USB connector, and more particularly to a micro USB connector capable of preventing a plug pushing a housing of the micro USB connector.

2. The Related Art

Conventionally, a micro USB connector is used to connect a computer and an electronic product such as mobile phone and digital camera, which has a small volume and a multifunction. The traditional micro USB connector includes a housing, a plurality of contacts received in the housing and a metal shell shielding the housing. The housing has a body, which has a front wall, a rear wall, a top wall, a bottom wall and two sidewalls. The front wall protrudes forward to form a plate-shaped mating portion. A plurality of cavities are defined in the mating portion and extends rearward to pass through the body for receiving the contacts therein.

However, when a plug is inserted into the micro USB connector overly, the plug is against the front wall of the body, then the body is easy to be pushed out of the metal shell. In this case, the contact received in the housing has an unsteady connection with a corresponding contact of the plug, therefore, the electrical connection between the micro USB connector and the plug will be unreliable.

### SUMMARY OF THE INVENTION

It is an object of the present invention to provide a micro USB connector capable of assuring a reliable electrical connection.

To achieve the above object, the micro USB connector comprises a housing, contacts received in the housing and a metal shell shielding the housing. The housing has a body, the body has a front wall, the middle of the front wall extends forward to form a mating portion, the top wall of the body defines at least one recess passing through the front wall and adjacent to the mating portion. The metal shell has a top plate, a bottom plate and two side plates, a receiving space is formed among the top plate, the bottom plate and the two side plates. The metal shell extends towards the receiving space to form at least one blocking portion. The body is received in the rear of the receiving space, the mating portion is received in the front of the receiving space, the blocking portion is located in the recess, a front end of the blocking portion protrudes forward out of the recess.

As described above, when a mating plug mates with the micro USB connector, the rear of the plug is against the front of the blocking portion to avoid the plug contacting the front wall of the body, then the contact received in the housing has a steady connection with a corresponding contact of the plug, therefore, the electrical connection between the micro USB connector and the plug is reliable.

### BRIEF DESCRIPTION OF THE DRAWINGS

The invention, together with its objects and the advantages thereof may be best understood by reference to the following description taken in conjunction with the accompanying drawings, in which:

FIG. 1 is a perspective view of a first embodiment of a micro USB connector in accordance with the present invention;

FIG. 2 is an exploded view of the micro USB connector shown in FIG. 1;

FIG. 3 is a partial enlarged view of the encircled portion labeled III shown in FIG. 2;

FIG. 4 is a cross-sectional view showing the micro USB connector shown in FIG. 1 mating with a plug;

FIG. 5 is a perspective view of a metal shell shown in a second embodiment of the micro USB connector;

FIG. 6 is a partial enlarged view of the encircled portion labeled VI shown in FIG. 5;

FIG. 7 is a perspective view of a metal shell shown in a third embodiment of the micro USB connector; and

FIG. 8 is a partial enlarged view of the encircled portion labeled VII shown in FIG. 7.

### DETAILED DESCRIPTION OF THE PREFERRED EMBODIMENT

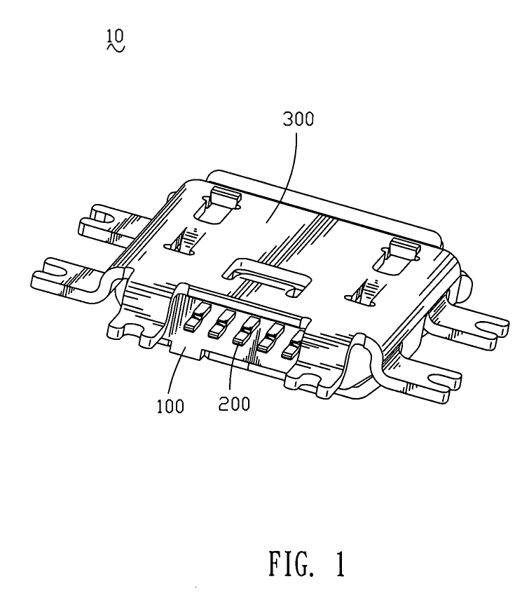

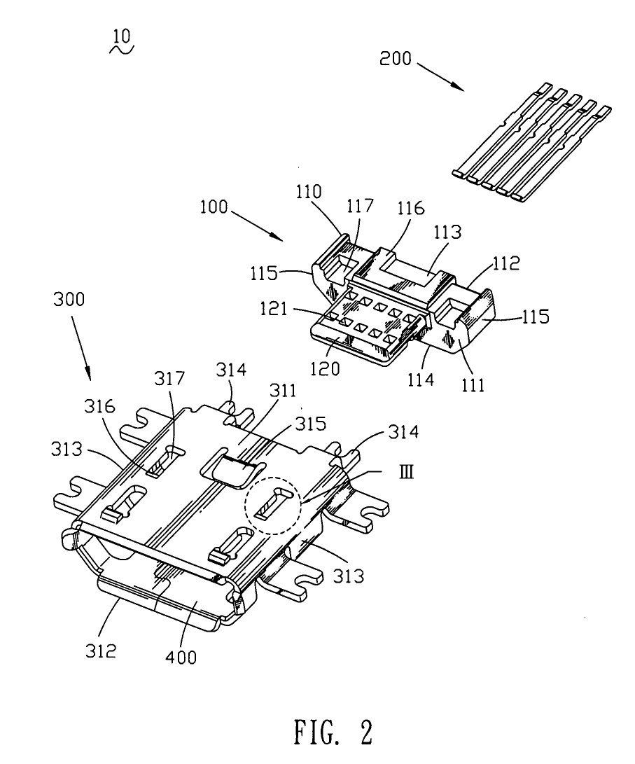

Referring to FIGS. 1 and 2, a micro USB connector 10 according to the present invention includes a housing 100, a plurality of contacts 200 received in the housing 100 and a metal shell 300 shielding the body 100.

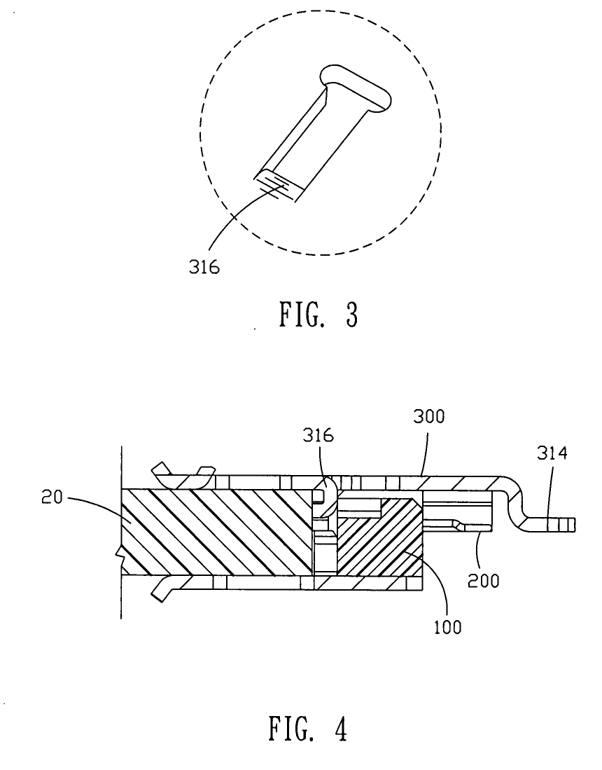

Referring to FIGS. 2 and 3, the housing 100 has a body 110, the body 110 has a front wall 111, a rear wall 112, a top wall 113, a bottom wall 114 and two sidewalls 115. The middle of the front wall 111 extends forward to form a plate-shaped mating portion 120. A plurality of cavities (not shown) are defined in the front of the mating portion 120 and extend rearward to pass through the body 110. The mating portion 120 defines two rows of holes 121 therethrough which communicate with the corresponding cavities. The middle of the top wall 113 protrudes upward to form a supporting portion 116, the supporting portion 116 has a base extending transversely and two branches extending rearward from two ends of the base, then a gap is formed therebetween. The top wall 113 defines two recesses 117 at two sides of the supporting portion 116. The recess 117 passes through the front wall 111 and is adjacent to the mating portion 120.

Please refer to FIGS. 2 and 4, the metal shell 300 has a top plate 311, a bottom plate 312 and two side plates 313, a receiving space 400 is formed among the top plate 311, the bottom plate 312 and the side plates 313. Two sides of the rear end of the top plate 311 extend downward and then rearward to form a soldering portion 314. The middle of the rear of the top plate 311 is cut to form a fixing portion 315, which has a connecting end integrating with the top plate 311 at the rear and a free end at the front. The free end of the fixing portion 315 leans downward a little. The top plate 311 defines two slots 317 extending from front to rear at two sides of the fixing portion 315. The top plate 311 extends downward and then bends forward to form a U-shaped blocking portion 316 from a front edge of the slot 317, the blocking portion 316 is at the front of the fixing portion 315.

Referring to FIG. 4, when the micro USB connector 10 is assembled, the contact 200 is received in the corresponding cavity of the housing 100, a part of the contact 200 stretches into the hole 121. The body 110 is received in the rear of the receiving space 400 of the metal shell 300, the mating portion 120 is received in the front of the receiving space 400. The fixing portion 315 lies in the gap and is against the rear of the base of the supporting portion 116 for fixing the housing 100 in the receiving space 400. The blocking portion 316 is located in the corresponding recess 117 of the body 110, the front of the blocking portion 316 is at the front of the front wall 111 of the body 110.

When a mating plug 20 mates with the micro USB connector 10, the plug 20 is inserted into the receiving space 400 from the front of the receiving space 400. The rear of the plug 20 is against the front of the blocking portion 316 to avoid the plug 20 contacting the front wall 111 of the body 110, then, the contact 200 received in the housing 100 has a steady connection with a corresponding contact of the plug 20, therefore, the electrical connection between the micro USB connector 10 and the plug 20 is reliable.

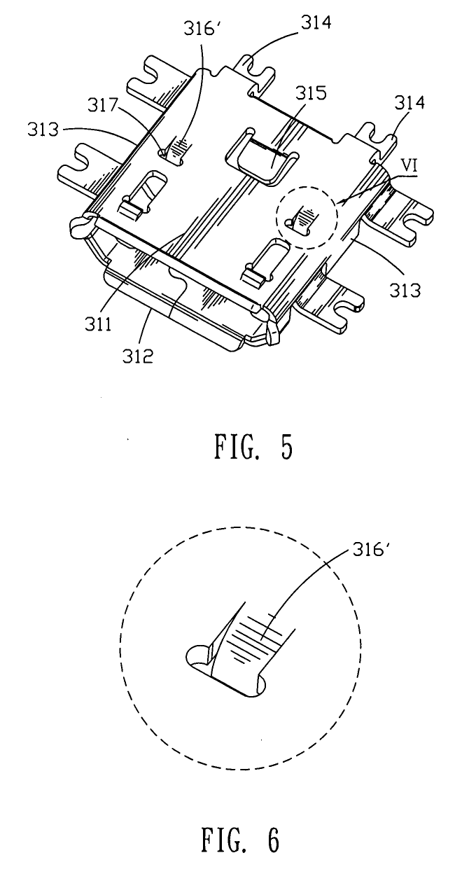

Referring to FIG. 5 and 6, a second embodiment of the present invention is shown. This embodiment is similar to the first embodiment, the difference between the two embodiments is: the top plate 311 extends downward to form a plate-shaped blocking portion 318 from a rear edge of the slot 317 instead of the blocking portion 316 in the first embodiment, the blocking portion 318 is at the front of the front wall 111 of the body 100, the recess 117 is not necessary to be defined in the top wall 113 of the body 100. When the plug 20 mates with the micro USB connector 10, the blocking portion 318 has the same action and effect as the blocking portion 316.

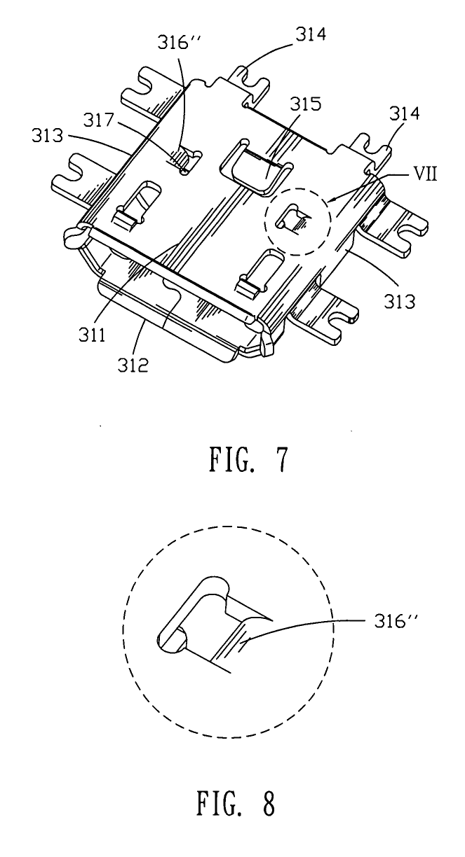

Referring to FIG. 7 and 8, a third embodiment of the present invention is shown. The difference between the two embodiments is: the top plate 311 extends downward and then bends sideward to form a U-shaped blocking portion 319 from a side edge of the slot 311, the blocking portion 319 is at the front of the fixing portion 315. When the plug 20 mates with the micro USB connector 10, the blocking portion 318 has the same action and effect as the blocking portion 316.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A micro USB connector, comprising:
a housing, having a body, the body having a front wall and a top wall, the middle of the front wall extending forward to form a mating portion, the top wall of the body defining at least one recess passing through the front wall and adjacent to the mating portion;
contacts, received in the body; and
a metal shell, having a top plate, a bottom plate and two side plates, a receiving space formed among the top plate, the bottom plate and the two side plate, the metal shell extending towards the receiving space to form at least one blocking portion, the body received in the rear of the receiving space, the mating portion received in the front of the receiving space, the blocking portion located in the recess, a front end of the blocking portion protruding forward out of the recess.

2. The micro USB connector as claimed in claim 1, wherein the top plate defines two slots at two sides thereof.

3. The micro USB connector as claimed in claim 2, wherein the blocking portion extends downward and then bends forward from a front edge of the slot to show a U-shape.

4. The micro USB connector as claimed in claim 2, wherein the blocking portion extends downward and then bends sideward from a side edge of the slot to show a U-shape.

5. The micro USB connector as claimed in claim 2, wherein the blocking portion extends downward from a rear edge of the slot to show a plate-shape.

6. The micro USB connector as claimed in claim 1, wherein the middle of the rear of the top plate is cut to form a fixing portion, which has a connecting end integrating with the top plate at the rear and a free end at the front, the free end of the fixing portion leans downward a little.

7. The micro USB connector as claimed in claim 6, wherein the middle of the top wall protrudes upward to form a supporting portion, the fixing portion is against the rear of the supporting portion.

8. The micro USB connector as claimed in claim 7, wherein the supporting portion has a base extending transversely and two branches extending rearward from two ends of the base, then a gap is formed therebetween, the fixing portion lies in the gap and is against the rear of the base of the supporting portion.
